(19) United States
(12) Patent Application Publication
(10) Pub. No.: US 2023/0401927 A1
(43) Pub. Date: Dec. 14, 2023

(54) TIERED PAYOUT GAMING SYSTEM AND METHOD

(71) Applicants: Vache OURFALIAN, Heath, TX (US); Nick PARKER, Heath, TX (US)

(72) Inventors: Vache OURFALIAN, Heath, TX (US); Nick PARKER, Heath, TX (US)

(21) Appl. No.: 18/208,139

(22) Filed: Jun. 9, 2023

Related U.S. Application Data
(60) Provisional application No. 63/350,758, filed on Jun. 9, 2022.

(51) Int. Cl. G07F 17/32

(52) U.S. Cl. CPC G07F 17/3244; G07F 17/3225; G07F 17/3288

(57) ABSTRACT

A sporting event wagering system for accepting auction bid amount for a plurality of sporting event participants and computing a prize purse from the collected winning auction bid amounts and assigning a payout to users owning a sporting event participant that wins one or more contests of a sporting event, the payouts assigned according to predefined payout rules that are optionally modifiable by the users.

### PRIORITY CLAIM

This application claims priority to U.S. Provisional Application No. 63/350,758 filed Jun. 9, 2022, which is incorporated by reference herein in its entirety.

### FIELD OF THE INVENTION

The present invention relates to sports gambling and wagering applications, systems and methods, and more specifically, to a downloadable application program for a portable device that allows tiered wagering on teams or individual sports participants, with wagerer payouts made according to team or individual participants level of progression in the particular event, game or tournament.

### BACKGROUND

### Description of Related Art

User wagering on sporting events has taken place for many years. In recent years, various computerized gambling sites have been made available to users. Through a user's desktop or laptop computer, or a personal data appliance such as a tablet or smartphone, a user can download an application program to enable wagering on various sporting events. Through these application programs, which are comprised of executable code executed by the device's processor, user's can subscribe to a particular provider's platform, maintain an account bearing funds for wagering, and wager on various events. The described wagering apparatus, system and methods described herein can be made available to users via a web enabled platform, accessible through a browser, the techniques of which are known in the art.

Such programs typically allow for a user to bet on the winner or loser of a sporting event, or whether a team or teams' total points scored in the game or part of the game exceed or fall below a predefined number. Not all events, however, lend themselves to just a single “win or lose” proposition. Some major events entail various rounds of games among a plurality of teams in a single elimination format or a “best of” series format. One well-known multi-team and multi-round event is the NCAA Basketball Championship Tournament, commonly known as the “March Madness” tournament. In the March Madness tournament, sixty-four teams are selected to participate in a single elimination tournament of games in which four groupings or geographic regions of sixteen teams each play other teams within a grouping. Teams within a grouping or region is seeded first through sixteen, with the strongest team seeded first, through the weakest team in the region designated the sixteenth seed. A team seeded first is considered to be a “higher” seed than a team seeded second, with the second seeded team considered the “lower” seed as compared to the first seed. The first seed is the “highest” seed and the sixteenth seed is the “lowest” seed.

In this tournament format, there are six rounds of games in each region. In the first seeded team plays a first round game against the sixteenth seeded team, the second seeded team against the fifteenth seeded team, the third seeded team against the fourteenth seeded team, and so on through the eighth seeded team against the ninth seeded team. In the second round in each region, the winner of the game between seeds one and sixteen plays the winner of the game between seeds eight and nine (“the 1/16 v. 8/9 game”); the winner of the game between seeds two and fifteen plays the winner of the game between seeds seven and ten (“the 2/15 v. 7/10 game”); the winner of the game between seeds three and fourteen plays the winner of the game between seeds six and eleven (“the 3/14 v. 6/11 game”); and the winner of the game between seeds four and thirteen plays the winner of the game between seeds five and twelve) (“the 4/13 v. 5/12 game”) and the winner of the 3/14 v. 6/11 game plays the winner of the 4/13 v. 5/12 game.

In the third round in each region, the winner of the 1/16 v. 8/9 game plays the winner of the winner of the 4/13 v. 5/12 game and the winner of the 2/15 v. 7/10 game plays the winner of the 3/14 v. 6/11 game. Note that in the March Madness tournament, teams are not reseeded, although various embodiments of the presently described gaming system and methods are adaptable for reseeding teams in each round or at various times.

The winners of the games in the third round in each region play each other in the regional final, which is the fourth round. Following the fourth round, four teams remain, the winner of each region. Those four teams play in two semi-final games, and the winner of each semi-final game play in the championship game. These fifth and sixth round games are referred to as the Final Four.

There is a need for a gaming or wagering platform that allows users to bid on players or teams in a bracketed tournament single elimination or “best of” series elimination tournament and offers payouts according to a user's team's initial seeding and progression through the tournament.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a method of user enrollment in the wagering platform according to an embodiment.

FIG. 2 is a diagram of a method of an auction process for user purchase of teams or players according to an embodiment.

FIG. 3 is flowchart a method of payout to user's owning a winning team in a round of tournament games according to an embodiment.

FIG. 4 is a network diagram of a wagering platform according to an embodiment.

FIG. 5 is flowchart a method of payout to user's owning a winning player in a tournament according to an embodiment.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE EMBODIMENTS

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The embodiment herein described is not intended to be exhaustive or to limit the invention to the precise form disclosed. It is chosen and described to explain the principles of the invention and its application and practical use to enable others skilled in the art to follow its teachings.

In terms of wagering, according to an embodiment of the presently describing wagering platform, a user enrolled in the wagering system bid on a team or teams that are one of the number of teams participating in the tournament. The bid is an auction process where the user making the highest and last bid for a team “owns” the team for the tournament. In an elimination-style “bracket” as is used in a tournament such as March Madness, the higher seeded teams, particularly the four first seeds, are expected to reach the Final Four. As such, the bids for those top teams are higher, or those teams are more expensive to own, because the likelihood that these teams will advance to the Final Four with one winning the championship are higher than the likelihood of a lower seeded team reaching or winning the championship.

In one embodiment, one user bids on a team or multiple teams and is the single “owner” of that team or teams. In another embodiment, two or more users are designated as co-bidders of a team or teams. In this scenario, each user will pay an equal share for each team and own an equal share. In another embodiment this co-bidder scenario is optional in that a user may own teams alone and may own teams with a co-bidder. In the co-bidder context, the co-bidders submit a single bid on a team or teams, but will own the teams jointly, share profits equally, as agreed upon, etc. A user, therefore, is able to bid alone for one team or teams and bid with a co-bidder on other teams.

Note that in a tournament such as March Madness, each college basketball team's regular season performance determines its seeding in the tournament, if the team makes the tournament at all. Typically, a team that makes the tournament has at least a winning record during the regular season in order to be selected to participate in the tournament. An exception is that NCAA conference tournament winners receive an “automatic bid” or “automatic selection” into the tournament. By example, if Michigan wins the Big Ten College Basketball tournament, which is played at the end of the conference regular season, then Michigan is invited to play in the March Madness tournament. Michigan is invited regardless of its record over the course of the season, even if a losing record. What this means is that there are teams that somewhat miraculously make it to the tournament as conference tournament champions despite a relatively poor performance over course of the four month basketball season.

The remaining teams, selected by a committee, that had relatively strong regular season records but did not win their respective conference tournament receive an “at large” bid to join the tournament. In the Michigan example, if Ohio State's basketball team had a very strong season yet lost the Big Ten tournament (to Michigan or another team) it would likely receive an at large bid to join the tournament based on its overall season performance or “body of work” for the season.

When the teams that are selected to play in the March Madness tournament, the well known tournament bracket is typically published for fans of the sport to follow the progress of the teams through the tournament. Many other sporting events lend themselves to this type of match presentation. Tournaments such as the FIFA World Cup for soccer, the NBA, NHL and NFL playoffs, match play golf tournaments and others are premised on a higher seeded team or player playing a lower seeded team or player, with the goal of advancing through all of the rounds of matches, with all teams eliminated at the end with the exception of the winner. For these other sports, individuals or teams may be purchased through an auction process, the auction proceeds comprising a purse, and round by round payouts made from the purse according to the seeding of the winning team.

In terms of a user's bid for a team, teams such as Michigan in the example would likely be inexpensive to own as a team that has a poor regular season yet wins its conference tournament is unlikely to advance to the championship game, let alone win it. Despite this logic, a user may at times “overpay” for a particular team out of a sense of loyalty to the school.

While logic dictates that the higher seeded teams should be more expensive and should advance far into the tournament, when the actual tournament is played, such is rarely the case. In many times over the years of the tournament, relatively small and unheralded basketball teams upset large, powerhouse teams. These upsets tend to throw that region into an unpredictable scenario, with the Michigan's in the example advancing far into the tournament against odds and logic while strong teams throughout the season are defeated in early rounds. This is one reason that the tournament, played primarily in the month of March, has earned the moniker March Madness.

According to one embodiment of the wagering system and method of the present disclosure, a group of users purchases all of the sixty-four participating teams, with each user owning one or more than one team. The money or other items of value collected for the teams from the users comprises a purse. A designation for distribution of the purse is made by the manager of the particular tournament including a finite number of users.

In one embodiment, the administrator sets the cumulative amount of individual round payouts at a fixed percentage of the total purse. Each winning team in a round receives the same payout as every other winning team. The payout methodology is customizable according to the objectives of the administrator or the participant users.

In another embodiment, a weighted payout is made depending on the team that advances. By example, assume that Michigan in the example is seeded fourteenth. In a first round game against the third seed, which is a high seed, Michigan is expected to lose. As such, the payout should Michigan advance in one embodiment is set as a relatively high percentage of the amount paid by the user for Michigan.

Under either payout embodiment, the payout level provides incentive to purchase Michigan (or lower seeded teams) in the first place as, again, the odds are that the lower seeded teams like Michigan will lose immediately in the first round to a high third seed. In reality, however, the lower seeded team sometimes wins. Thus, the owner who paid little for a lower seeded team immediately realizes a profit from one win by his or her lower seed.

Conversely, the third seed, for example, Kansas, a relatively expensive team for a user to own, is expected to at least defeat Michigan and should advance to the third round of games. As such, the profit to the user owning Kansas is relatively low (or may not even be realized yet if the purchase price was high) should Kansas defeat low seeded Michigan as expected. Recall that there are thirty-two games in the first round of the tournament, meaning there are thirty-two winners.

Conversely, for lower seeds winning the first round game, even if every winning team receives the same payout as a fixed amount based on a percentage of the total purse dedicated to the first round, the individual user profit is higher (relative to the initial investment made by the owner) for those owners of winning lower seeded teams. That is, the owner of a winning low seeded team made a small investment but enjoys a larger return than the winning high seeded team. This assumes that the higher a team is seeded, the more that team costs to own.

The same payout methodology is followed for subsequent rounds of games, with a total payout purse for the second round calculated, which is a fraction of the remaining purse paid following the first round payouts. In one embodiment, the aggregate payout for all winning teams in the second round is higher than the aggregate payment in the first round, as a team (and owner user) is more greatly rewarded for winning two tournament games and advancing to the third round. Like in the first round, in one embodiment, each winning team in round two receives the same amount, regardless of seeding.

The methodology of the presently described wagering platform offers an advantage to those familiar with the underlying sport and the various teams that are relevant to an auctioned team's success. For instance, once the March Madness tournament bracket is set, a user that is acutely familiar with that season's college basketball results, individual player performances, etc., the user can strategize in making bidding decisions based on knowledge of a team of interest as well as other teams standing in the path of a team of interest from advancing in a tournament. The same holds true for golf, as will be discussed. Various players may be on “hot streaks” or be playing on a course not conducive to a player's ball flight, length in terms of driving the ball, or the like. Thus, there is a high level of user skill and knowledge involved in determining which player to bid on and how much to pay.

In another embodiment, the payouts may be weighted, with lower seeded teams awarded a higher payout for defeating a higher seed. In the Michigan example, if Michigan as a fourteen seed defeats Kansas the third seed in the 3/14 game, Michigan would then play the winner of the 6/11 game. If the sixth seed, UCLA, won that 6/11 first-round game, and then Michigan defeated higher seeded UCLA in the second round, then Michigan's owner user would receive a relatively high payment for upsetting two teams in the first two rounds, as compared to a number one seeded team winning its first two games, as expected. This payout methodology rewards the risk of purchasing lower seeded teams.

Once a user purchases a team, then the price paid for the team is made part of the purse and is not refunded if that team is eliminated. In one embodiment, the round by round payouts that are awarded a team are non-refundable. That is, these payouts vest in the user regardless of whether that team ultimately loses. In an alternative embodiment, however, the user that has won one or more rounds has the option of “cashing out” or continuing on a “winner take all” basis. In a winner-take-all context, when the tournament or event proceeds to the final game with two teams, only two owners remain and the winning owner will win the win the entire pot. In one embodiment, the final two owners may elect to “split the pot” before the final game or match is played. That is, the two owners must agree that the winner's share will be split between the two owners. This operates as a “hedge”, permitting each owner to significantly reduce the odds of taking nothing. This, however, requires agreement among both owners. This can also be invoked among four final owners of teams in a semi-final round, requiring agreement among all four owners. Should the decision to split the pot not be unanimous, in the winner take all format, the loser takes nothing, including the initial investment to purchase the team or player.

Assume in our example that a user purchases fourteen seeded Michigan for $30. Also assume that after winning its round one game as the lower seed the Michigan user is awarded $15 and after winning the second round game that user is awarded another $20. After each round, the Michigan user is given the option of quitting and taking the $35 in payouts or “letting it ride” on Michigan winning another round. This gives the user the opportunity to recoup the initial investment and not risk forfeiture of both the initial investment and the round by round payouts in the event that Michigan loses in the next round. Variations of the round by round payout methodology are predetermined by the administrator. In one embodiment, the round by round payments are made in addition to the large prize awarded to the winning team.

In another embodiment, a user has the option to place his team up for re-auction in the middle of a tournament or event. This enables the owner of a team to recoup his investment before the team either wins the tournament, advances further, or is eliminated by selling the team to another user. This feature could be particularly relevant in a March Madness scenario where a very low seeded team upsets a team or two, tempting other users to acquire it in hopes of procuring future per-round payouts for a minimal investment.

In one embodiment, user participants pay for winning bids in the local currency, such as U.S. dollars or the currency of the particular location, according to the desires of the league. In the alternative or in addition, users can pay in other forms of currency such as crypto-currency or other suitable form of payment.

### Tournament Participant Set Up

Prior to starting an auction process for a particular tournament such as March Madness, a user must be enrolled as a participant via the dedicated application program on a smart device or the like. Users enroll by providing standard information and means for electronic payment of a team's purchase. The administrator of the tournament sets up a designated account for receipt and safekeeping of proceeds from the auction and from which round by round payouts may be made.

### Auction Process

Once a sufficient number of users are enrolled in the gaming platform of the present invention, an auction process ensues for purchasing of teams. Using the March Madness basketball tournament as an example, teams are bid on as is known for auctions. When bidding via a digital device, users have a set period of time in which to place a bid. Assuming the bidding starts on Michigan. Once the bidding starts, a timer starts and a first bid is awaited. Once a first bid is received, the timer is reset and run, giving a second user the time remaining on the timer to place a bid higher than that of the first user. Once the second user bids, the timer resets and a third user or the first user may place a bid. If a bid is placed before the time remaining to bid expires, then this process is repeated and another may bid. If, however, at any point the timer expires, the last bid is deemed the winning bid and that team is awarded to that user. This process continues for each team participating in the tournament, until all teams are sold. Some teams that are unsold are considered “house” teams and no payout is made if that team wins games.

It is contemplated that more than two owners will participate in the auction process. Bidding typically starts with the lower seeded teams, which are less costly, and progressing up towards the top seeded teams, which cost more to own. Individual users or user groups can own more than one team. All teams must either be sold or assigned to the “house” in order to complete the auction.

The tournament administrator sets a minimum bidding increment for the auction. A rule can be set in advance that a bid must be at least $5 greater than a previous bid. The administrator can set this minimum bid amount to any desired amount.

### Live Auctions and War Rooms

In one embodiment, a third party application program is associated with the application program of the present invention to facilitate a live auction setting. Through known video conferencing platform applications, each user participating in an auction is represented on the computer or smartphone display screen of all users. This provides an environment similar to a professional sports draft or tournament selection event, which makes the bidding process more entertaining. The video conferencing platform can also provide live streaming of games with live user representation on the screen. This allows users to observe the reactions of other owners as their respective teams win or lose games. In one embodiment, the level of features applied to an auction and a group of users can be based on payment of additional enrollment fees. In other embodiments, the war room feature can be standard. In another, users pay a base fee for each tournament in which they participate with the administrator personally receiving some or all of the fee or a user pays a monthly subscriber fee for ongoing participation as long as monthly payments are made.

As described, the arrangement for round by round payouts and for the establishment of the tournament group are customizable by the administrator and/or by vote of the participating users.

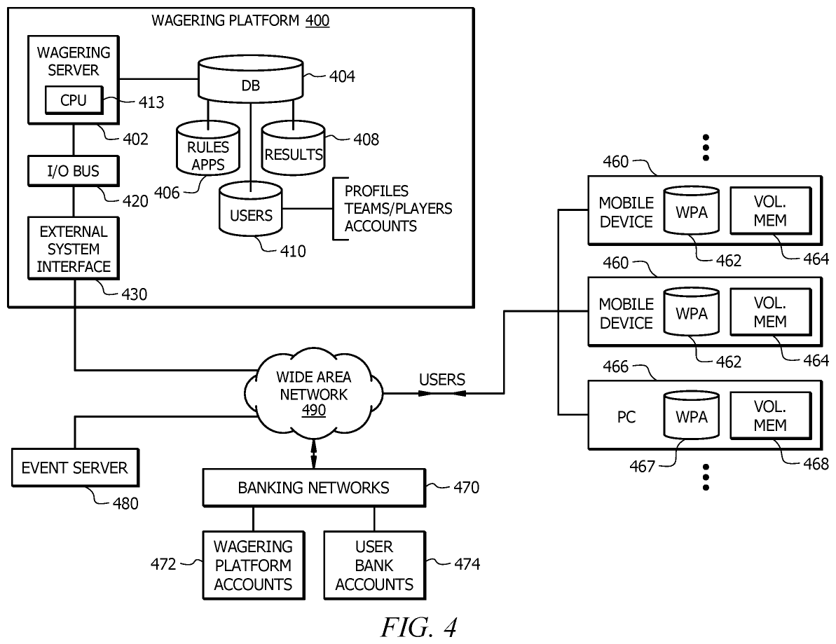

FIG. 4 is a network diagram of a wagering platform according to an embodiment. FIG. 4 depicts wagering platform 400, which performs much of the features and functionality of the presently described invention. Wagering platform 400 comprises wagering server 402, that itself comprises a central processing unit 403 and has an associated database 404. Database 404 includes rules applications 406, wagering even results 408 and user information 410. User information 410 includes user profiles, teams or players owned or co-owned by a user, and user accounts, including a bank account or payment account to which payments are made between the user and wagering platform 400. User profiles include various attributes of a user, including success rate, winning percentage and whether a user has achieved various levels such as elite status.

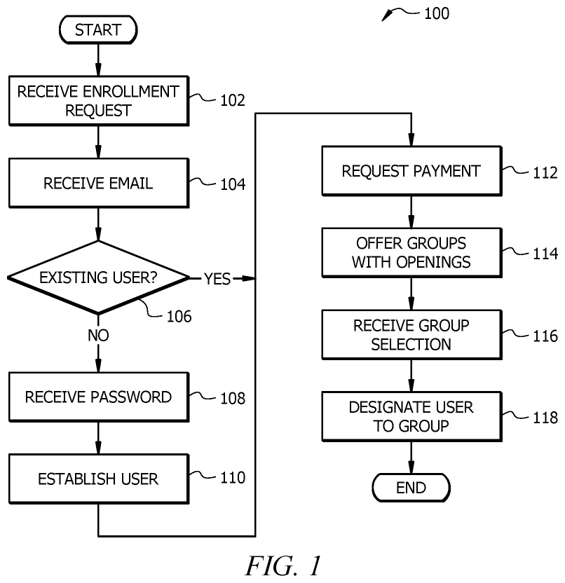

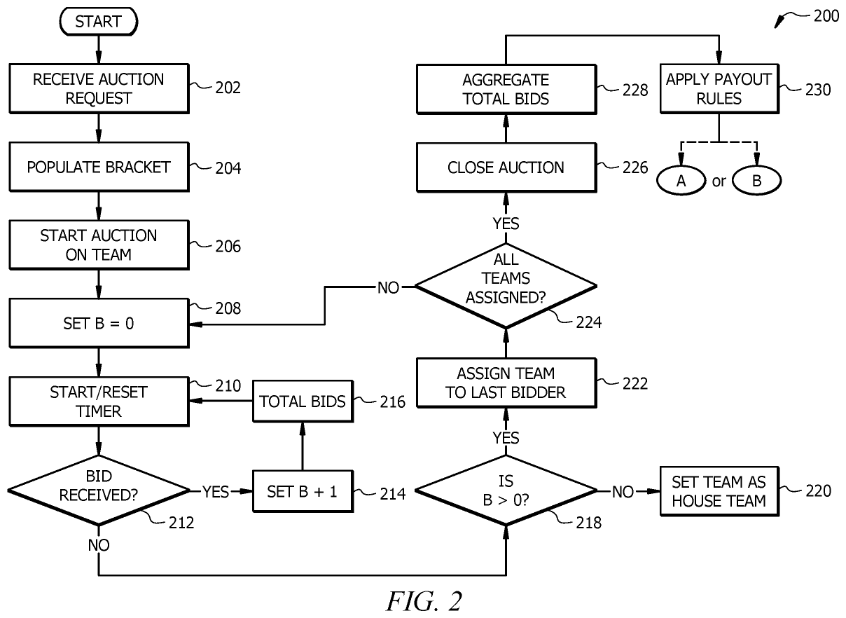

Rules applications 406 include the various rules set by default or by league administrators that govern a particular tournament in which the various users participate. These include auctioning rules as well as rules calculating user payouts based on success or the user owned team or player. An embodiment of rules that are invoked for events such as a March Madness tournament or a golf tournament that are executed by rules application programs 406 are described according to the methods described below in the flowcharts of FIGS. 2, 3 and 5. A rules application program 406 that governs and executes the player or team auction process is described according the methods described below in the flowchart of FIG. 1.

Rules applications 406 comprise computer readable code stored in non-volatile memory associated with processor 403 of wager server 402. Execution of the computer readable code causes the various rules governing operation of the wagering event to be invoked and control the functionality of the wagering platform.

Results database 408 includes results of various events as well as individual user results for partially and fully completed events in which that user has participated. Results database 408 is updated in real time as events such as basketball tournaments entail several games being played at one time, with the results of those games impacting the payout data for each individual owner. Wagering platform 400 receives event information from event server 480 via wide area network 490 and external system interface 430. Event server 480 makes available for retrieval by wagering platform 400 or pushes to wagering platform 400 in-game information and game results. Based on this event information, wagering platform 400 invokes rules application programs 406 to appropriately modify payout information for that game or event.

Wagering server 402 is associated with input/output bus 420, through which wagering server 402 communicates for wagering platform 400 with external devices via external system interface 430. Communication occurs via wide area network 490, which includes the internet and/or a cellular network of the like. Such external systems include banking networks 470, to which are associated the wagering platform account 472 and user bank accounts 474 that are tied to one or more financial institutions.

Users communicate with wagering platform 400 via wide area network 490 with mobile devices 460 or personal computers 466. Mobile devices, such as smart phones, tablets or other personal digital assistant devices comprise a processor and have downloaded thereon one or more application programs. Wagering platform application program 462 is stored in non-volatile memory of the mobile device. Wagering platform application program 462 is dedicated software enabling the user to communicate with wagering platform 400 and invoke various operations in order to participate in wagering events. Wagering platform application program 462 provides the user with various interfaces through which the user enrolls as a wagering platform user, establishes a user profile, link a bank account through which the user wishes to accept payments from and make payments to wagering platform 400, and invoke various other features of the wagering platform offerings. Mobile device 460 also includes volatile memory through which the user receives among other things, real time information based on team or player event information pertinent to the user.

In one embodiment, the mobile user is presented with real time value information, as described below, related to a current bid price for a player or team. This information serves as, in essence, a recommendation on whether a player or team should be purchased. The value information is created by wagering platform 400 according to information about the wagering event and the teams involved and the potential purse for the event. This information is stored in volatile memory 464 of the mobile device 460 and made available to the user while the wagering platform application program is open and running on the device. In one embodiment the information is updated at regular intervals as other players or teams are purchased, modifying the relevant value of the player or team in terms of potential profit or loss.

Personal computer devices 466 similarly include a processor and wagering platform application program 467 stored in non-volatile memory of the device. Wagering platform application program 467 is dedicated software enabling the user to communicate with wagering platform 400 and invoke various operations in order to participate in wagering events. Wagering platform application program 467 provides the user with various interfaces through which the user enrolls as a wagering platform user, establishes a user profile, link a bank account through which the user wishes to accept payments from and make payments to wagering platform 400, and invoke various other features of the wagering platform offerings.

In one embodiment, the personal computer user is presented with real time value information, as described below, related to a current bid price for a player or team. This information serves as, in essence, a recommendation on whether a player or team should be purchased. The value information is created by wagering platform 400 according to information about the wagering event and the teams involved and the potential purse for the event. In an embodiment this information is stored in volatile memory 468 of personal computer 466 and made available to the user while the wagering platform application program is open and running on the device. In one embodiment the information is updated at regular intervals as other players or teams are purchased, modifying the relevant value of the player or team in terms of potential profit or loss.

In an embodiment, mobile devices 460 and personal computers 466 include banking application programs that allow users to direct transactions with their personal bank accounts. Wagering platform application program 462 and 467 includes a payment interface through which a user can link a financial account to wagering platform 400 or a third party payment platform.

FIG. 1 is a flowchart of a method 100 of user enrollment in the wagering platform according to an embodiment. Enrollment method 100 starts at step 102 with the wagering platform receiving a request from a user to enroll or become a member of the wagering platform. Enrollment enables the user to bid on teams that are participants in bracketed tournaments where a team must defeat several teams to advance to a final championship game, match or series. At step 104, the wagering platform receives a unique identifier from the user, such as an email address or a user name comprised of letters, number and/or special characters. At step 106, the platform queries whether the user's name or email is already that of a registered member of the platform. If the answer is “no”, then the user is at step 108 presented with a window via the user interface of the application program to select a password for entering the platform and participating in auctions and tournaments. If, however, the answer at step 106 is “yes”, meaning the user is already enrolled, the user enters a password previously set, then method 100 proceeds to step 112 where a user is requested to make a payment. The payment is made via a credit or debit card number entered by the user via a suitable payment window, as is known in the art. In one embodiment, the administrator of the tournament can require a flat fee that a user must pay to participate in a tournament. Alternatively, there may be no participation fee. The payment form is stored by the platform and any team auctions won by this user will be charged against the payment card. In an embodiment, the platform sells users a number of credits for a set price. The credits are stored in a user account and associated with the user's unique identifier. When the user wins an auction and purchases a team, the cost of the team is deducted from the credit amount.

Next, at step 114 once the user is enrolled the platform presents a number of tournament groupings that have openings for new owners that a particular administrator is operating. In one embodiment, there is no limit to the number of users that may participate in a team auction for a tournament. However, only users that purchase at least one team at auction are eligible to receive payouts for round by round wins, as will be described.

In another embodiment, a user may wish to join other known users in a private tournament auction. For such auctions, an administrator sends the user via email, SMS message or the like an invitation to join a private group auction. Customized rules for private group auctions may be set by the administrator according to vote of the joining users. For example, a finite number of users may be permitted to join, with each user required to purchase at least one team and expend a minimum amount of funds for each user's purchased players. Payout scenarios are also customizable.

If a user opts to join a standard auction, which is one that is publicly available and had no limit to the number of participants, the user is presented with a list available auctions. Standard auctions potentially include thousands of users, where many users bid for each available team. Such an auction setting has the potential to create a very substantial prize purse. In the alternative, a private group auction with fewer participants can also result in a high prize purse if the minimum team bid is substantial and each user must spend a minimum amount. The list includes a date and time of the auction and an interface that allows a user to pre-select the amount of money or credits that the user wishes to bid on a team. At step 116, the platform receives the user's selection of the auction he or she wishes to join. Then, at step 118, method 100 ends with the platform designating a group auction to the user.

FIG. 2 is a diagram of a method of an auction process for user purchase of teams or players according to an embodiment. Auction method 200 starts at step 202 where the wagering platform receives a request from a group auction administrator to begin a team auction. At step 204 a bracket, such as the March Madness bracket, is populated. At the start of the auction the bracket shows only the teams, their seeding and first round opponent. Once a user purchases a team, that user's user name is shown as that team's owner.

Next, at step 206 the platform begins the team auction process. At step 208 a counter B, that represents the number bids received for a team, is set at zero. Next, a timer, which represents the time by which a bid for a team must be made, is set at a designated time and started. By example, an administrator may set the time for thirty seconds. That is, if a bid is made and no other bid is made in thirty seconds, the user who made the pending bid wins that team. More or less time may be set for the timer. In the alternative, in private auctions the league administrator or commissioner may opt for not invoke a time limit for making a bid. In this scenario, the commissioner is charged with assigning final designation of teams or players to bidders if no additional bids are made.

Next, method 200 proceeds to step 212 where the platform queries whether a bid was received for the team up for auction. If the answer is “yes”, then the process moves to step 214 where the counter B is increased by one. At step 216, the bid amount above the most recent bid is added to a total purse, and the process reverts back to step 210 where the timer is reset and at step 212 the question is again asked if a bid was received. With each bid received the timer is reset.

If, the answer at step 212 is “no”, meaning no bid was received at the expiration of the timer, then at step 218 the platform queries if the value of B (number of bids) is greater than zero. In other words, has at least one bid been made for a team. If the answer is “no”, meaning no bid was made for a team, then at step 220 that team is designated as a “house team”. For a house team, no payout is made if that team wins a tournament game. In other embodiments where the auction rules require that each team must make at least a minimum bid on each team, there is no designation of a team as a “house team”.

If, on the other hand, at step 218 the answer is “yes”, meaning at least one bid was made on a team, then at step 222 that team is assigned to the last bidding user as the owner. Then, at step 224, the platform queries whether all teams have been assigned to a user or to the house. If the answer is “no”, the method reverts back to step 208 where the value for B is reset at zero and the method proceeds as before to step 210 and beyond.

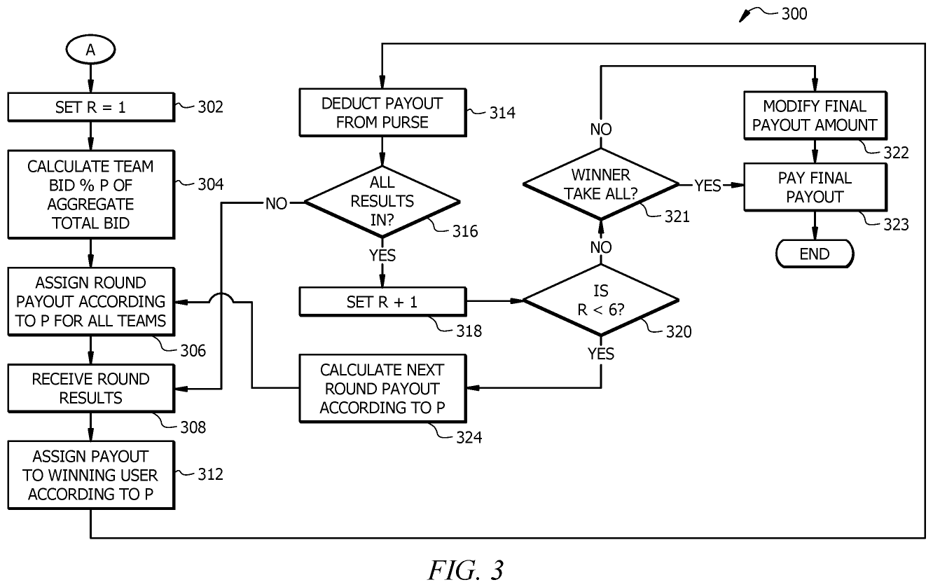

If, however, the answer to the query at step 224 is “yes”, that all teams have been assigned, the platform messages the users at step 226 that the auction has ended. Then at step 228 the amount of the winning bids is totaled and stored, and at step 230 method 200 ends with application of the payout rules for this groups auction at step 230 and the method then proceeds to application of the payout rules as depicted in FIG. 3.

In an embodiment, the presently described wagering platform provides users with projected payouts as the event ensues. A statistical dataset provides users of a team of interest's value in terms of the currently available projection of the payout should the team of interest advance to win the event. For example, in the March Madness context, if the bid for a top seed team is $2000 and the pot or total purse is $35,000, the data set will indicate that the top seed need only advance to the third round of the tournament for the bidder/purchaser to break even. In theory, a top seed is expected to advance to the Final Four. Any victories by the top seed beyond the third round will result in a profit for the owner. This information indicates to the bidder whether a current bid for a team represents good value. In contrast, a team with lower probability of advancing beyond the first round or two should be available for purchase for a lower price. Should the data set show that the current bid for the team is at a level that would require the team to advance several rounds in order for the purchaser to break even. For a lower seeded team, there is a lower probability that it will advance several rounds. Thus, a bid at a level where the low seeded team would need to advance several rounds to allow the purchaser to break even would not represent a good value. In real time a value indicator is presented to the user via the user's interface during the bidding process, indicating if the current bid for a player or team represents good value or not.

In one embodiment of the auction process, there is no maximum limit on how much an individual participant may spend on a team or teams. In another embodiment, the administrator sets a ceiling on the amount any individual may spend on a team or teams. This lends itself to more strategy employed by players in stretching available funds to acquire teams.

FIG. 3 is flowchart a method of payout to user's owning a winning team in a round of tournament games according to an embodiment. The method of FIG. 3 ensues at point “A” following step 230 of the method of FIG. 2. Payout method 300 starts where auction method 200 ended. At step 302, the platform sets value R to 1. Value R represents the number of rounds or series in an elimination tournament. In one embodiment, the tournament is a six round tournament, beginning with sixty-four teams playing thirty-two single elimination games, with subsequent rounds two, three, four, five and six comprising sixteen, eight, four, two and one games, respectively.

Next, at step 304, the percentage P of money paid for each team as compared to total amount of bid proceeds collected for all teams is calculated and stored. At step 306, a first round payout amount is assigned to each team according to percentage P. That is, based on the total amount collected and the percentage of total bid proceeds collected for a team, a first round win award is determined for each team and stored.

Method 300 continues at step 308 where the platform receives a game result, indicated the winning and losing team of at least one game. At step 312, a payout amount is assigned to the winning team of the reported game according to P and the round payout determined at step 306. Next, at step 314, the amount of the payout amount designated at step 312 is deducted from the total purse amount and stored.

Next, at step 316, the system queries if all game results have been reported. For the first round, the system expects to receive thirty-two game results in a sixty-four team embodiment. With receipt of each result, a counter starting at zero is incremented by one with each result received. If the answer at step 316 is “no” that all round results have not been reported, then method 300 reverts back to 308 and the platform awaits another game result.

If the counter amount equals thirty-two, the answer at step 316 is “yes” as all teams have been designated a payout. Then at step 318, the platform increases R by one. Then at step 320 the system queries if R<6, meaning fewer than all six rounds have been played. Ifthe answer is “no”, then all six rounds are complete, the tournament has a winner. At step 321, the query is posed whether the “winner take all” rule has been invoked by agreement of remaining finalists. If the answer is “no”, meaning it is not a winner take all payout, at step 322 the previously set final payout amount is modified according to a split or other division of the winner purse according to agreement of the finalists. The method then completes at step 323 with the platform paying the final payout to each team by crediting each account of each user having an amount designated for payout.

If on the other hand the answer to query 321 is “yes” meaning it is a winner take all scenario, then the method proceeds to step 323 to pay the pre-determined payout amount to the winning player.

Note that at step 322 the final payout made to each user is according to league rules. The wagering platform in one embodiment assigns default wagering rules, that are modifiable by the group administrator. For example, in some groups once a user's team wins one game, the amount allocated to that user for that win vests with the user and is not lost if that user's team later loses. In the alternative, a group payout scheme is set according to “let it ride” rules. That is, a user with a winning team can opt to take some or all of the proceeds for a win and leave the game, but if the user wishes to continue, some or all of the previously allocated winnings are lost if that user's team loses a later game. The payout features, including minimum and maximum round by round payouts, winning vesting, minimum purse for a champion, semi-finalist and quarter-finalist are in one embodiment set at and made known to users prior to joining an auction group.

The embodiments described herein are premised on a sixty-four team single elimination tournament with four sets of sixteen teams participating in four groupings. In each grouping eight games are played in a first round. Teams are seeded from one to sixteen in each grouping, with the lowest number (for example, the number one) identifying the top or best team in a grouping and the highest number (for example, the number sixteen) identifying the lowest or worst team in the grouping. Such a seeding and grouping arrangement is not critical to the invention and the particular methods described herein. The disclosed methods lend themselves to re-seeding of teams and tournament having more or fewer rounds of game. Also, while reference is made to the March Madness basketball championship tournament, other sporting events that operate in a single game or series elimination format are amenable to the presently described wagering platform. Profession sports such as basketball, baseball and hockey use a series of games, rather than single games to determine if a team advances to a next round or is eliminated from the tournament. The user enrollment, auction conduct processes and payout method described herein lend themselves to virtually any tournament where the participants are “seeded” with each match able to be presented in bracket form or a similar format.

In another embodiment of the presently described wagering platform, a golf tournament is the sport of interest. Unlike a tournament such as the March Madness tournament, the typical professional golf tournament that is contemplated as the subject sport for wagering entails a field of players participating in a four round tournament. Usually, a “cut line” is established after the first two rounds of play. The cut line determines which players achieving a certain score relative to the leader of the tournament, limited to a certain number of total players, will advance to play in the third and fourth rounds of the tournament. For PGA tour events, only the players who “make the cut” play in the third and fourth rounds and only those players share in the prize purse. All players making the cut are awarded some percentage of the total purse, with the first place finisher awarded the highest percentage and each player in second, third, fourth place, etc., who played in all four rounds getting a smaller percentage, down to the last place player who played in all four rounds.

The number of players who make the cut is usually predefined by the tournament organizer and is a function of the size of the entire field starting the tournament. For example, for a tournament with one hundred forty participants at the start, only the top seventy scores after two rounds will be eligible to play in rounds three and four. In terms of score, this translates into a “cut line” in the form of a score within a number of strokes behind the leader. For example, if a leader is ten under par after two rounds, the cut line may be one under par, including ties. This means that any player having a score of one under par or better after two rounds will be eligible to play in rounds three and four. The cut line in terms of score is arbitrary and a function of how many players enter the tournament and the predefined number of players that will continue playing rounds three and four. This is different than an elimination style tournament as a golfer doesn't “win or lose” after the first or second round.

In terms of payout for a golf tournament that is the basis for wagering under the present wagering platform, in one embodiment a user owner in one embodiment is awarded a payout if his or her player “makes the cut” yet doesn't win the tournament. By example, the prize purse may be divided among the top five finishers, with the owner of the first place golfer awarded forty percent of the purse, the second place owner awarded twenty percent, the third place owner awarded fifteen percent, the fourth place owner awarded ten percent and the fifth place owner awarded seven and one-half percent. In this scenario, the top five player owners are awarded, cumulatively, 92.5 percent of the purse. This leaves seven and one-half percent for the entirety of the players making the cut who did not finish in the top five. This residual amount can be divided equally among owners of players making the cut and finishing out of the top ten or as otherwise designated by the administrator of the wagering. Likewise, the percentage of the purse awarded to the top five players may be modified or may be allocated among a different number of placing players. The payout scenarios are fully customizable by the administrator or by the vote of the participating users. The exact percentages and number of awarded players described above is not limiting but is illustrative.

The various embodiments described above are contemplated for “open entry” wagering. That is, there are no limits or prerequisites placed on a user wishing to participate in wagering on a particular sporting event, whether it be the March Madness tournament, a golf tournament or the like. In another embodiment, an auction is held for users to bid on other users who have participated in several wagering events and have achieved a high level of success. The users achieving a high level of success or elite status are themselves available for “purchase” by other players. This, in effect, results in users purchasing the elite players, rather than the underlying athlete or team. This is akin to a “mutual fund” of wagering, where the user purchasing a player of “elite status” is paid out according to the elite user's overall performance in underlying wagering events. In one embodiment, user's bidding on an ultimately purchasing elite users are periodically paid payouts according to the various elite user's performance during the designated period. The elite players are ranked according to their respective performances in underlying wagering events, and owner payouts are made according to the elite players' placement in the standings among all elite players. The elite user's place in the standings in this scenario is a function of prize money awarded to each elite player in the various underlying events. Different events in which the elite user was awarded prize money can, in one embodiment, be weighted to account for the level of participation and purse amount in the underlying tournament. The payout rules in this elite wagering context, like the other wagering games discussed, is fully customizable by the league administrator. Alternative, default rules for payouts may be applied. But fundamentally the concept is the same, where a user “purchases” an elite player for an event, or multiple events, or for a set duration of time, with payouts made according to the elite players underlying performance.

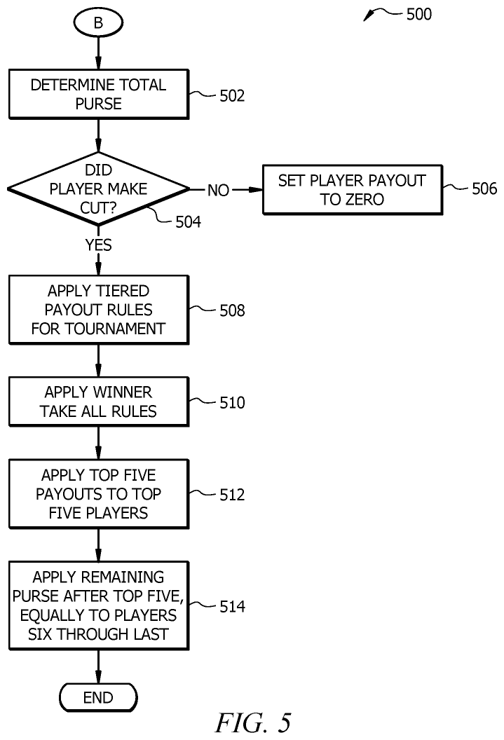

FIG. 5 depicts the steps of a method performed by a rules application program 406 of wagering platform 400 as applied to an event such as a golf tournament where not all owners of players receive a payment and a percentage of the total purse is awarded to each of a finite number of top finishers. The method of FIG. 5 is invoked at “B” following step 230 of the method of FIG. 2 in which payout rules are applied.

The method of FIG. 5 begins at step 502 where a total purse is calculated. The total purse is derived from the total amount of bid funds collected from users for the various players. This may be one hundred percent or less of the total collected. At step 504, the questions is asked whether a particular player made the cut. If the answer is “no”, then at step 506 the event information for the owner of that player is designated for no payment for this event. If, on the other hand, the answer at step 504 is “yes”, that the player made the cut, then predefined tiered payout rules for the event are applied at step 508. In one embodiment, the owners of the top five finishers may receive a set percentage of the total purse, such as forty percent for first place, twenty percent for second, fifteen percent for third, ten percent for fourth and seven and one half percent for fifth. Other values may be set by the administrator of the event.

At step 510, any winner take all option that was invoked by the owners of the top two or more player owners is applied. The winner take all option may entail all of the top five owners agreeing that only the winner receive payment, or fewer than the top five may agree that fewer than the top five payouts be subject to the winner take all option. If there was a form of a winner take all election invoked or not, then at step 512 the relevant top five winner's share is applied to each winner. Next at step 514, the remaining purse outside of the top five (or other predefined number of players receiving tiered payouts) is applied to the remaining players outside of the tiered payout places. At the selection of the administrator, the remaining purse is applied equally to all players outside of the tiered payout places or is applied in decreasing fashion from the first player placing below the tiered payout place to the player finishing last yet making the cut. The rules application is customizable allowing the administrator to select the desired payout protocol.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A method for storing a plurality of wager data from a plurality of individual users in a sporting event wagering game (i) non-volatile data storage, and (ii) a user device having a volatile data storage device, wherein the wager data for each individual wager includes an auction bid amount, a winning auction bid amount, a sporting event participant associated with the winning auction bid amount; a sporting event identifier, a prize purse and wager field, and a unique wager identifier, the method comprising:
(a) storing the wager data for each of the individual users in the non-volatile data storage;
(b) after an auction bid amount is stored in the non-volatile data storage, storing a part of the wager data for each of the individual wagers in the volatile data storage device, the stored portion of the wager data including at least (i) the auction bid amount and (ii) an associated sporting event participant associated with the auction bid amount;
(c) generating in real time a user recommendation to the user concerning the auction bid amount for the associated sporting event participant according to a most recent auction bid and storing the user recommendation in volatile memory;
(d) assigning a sporting event round payout for each of a plurality of sporting event rounds according to a predefined percentage of a total of funds received from winning auction bid amounts;
(e) designating a final payout amount as a percentage of the prize purse for each user according to a performance result of the sporting event participant; and
(f) transferring funds equal to the designated final payout amount to a designated financial account of each user.

2. The method of claim 1, wherein the sporting event is an elimination tournament played by a plurality of sporting event participants.

3. The method of claim 1, wherein the sporting event comprises multiple rounds of play by sporting event participants and wherein a winning spoiting event participant advances to a next round of play.

4. The method of claim 3, wherein the designated payout amount is designated for a participating sports team for each round to which the participating sports team advances.

5. The method of claim 1, wherein the user recommendation represents a relative monetary value of a participating sports team in view of the most recent auction bid.

6. The method of claim 1, further comprising assigning a participating sports team to the user when the user submits a last auction bid for the participating sports team.

7. The method of claim 1, further comprising receiving from at least two users an approval to modify the designated final payout amount.

8. The method of claim 1, wherein the sporting event participant is a sports team.

9. The method of claim 1, wherein the sporting event participant is an individual athlete.

10. A wagering system, comprising a wager platform having a wager server in communication with a plurality of user devices, the wager platform and user devices each having non-volatile memory devices and the user devices having volatile memory, comprising:
a rules application program comprised of computer readable code under the control of a wager server processor, configured wherein execution of the computer readable code by the wager server processor performs the following steps:
(a) storing the wager data for each of the individual users in the non-volatile data storage;
(b) after an auction bid amount is stored in the non-volatile data storage, storing a part of the wager data for each of the individual wagers in the volatile data storage device, the stored portion of the wager data including at least (i) the auction bid amount and (ii) an associated sporting event participant associated with the auction bid amount;
(c) generating in real time a user recommendation to the user concerning the auction bid amount for the associated sporting event participant according to a most recent auction bid and storing the user recommendation in volatile memory;
(d) assigning a sporting event round payout for each of a plurality of sporting event rounds according to a predefined percentage of a total of funds received from winning auction bid amounts;
(e) designating a final payout amount as a percentage of the prize purse for each user according to a performance result of the sporting event participant; and
(f) transferring funds equal to the designated final payout amount to a designated financial account of each user.

11. The wagering system of claim 10, wherein the computer readable code is configured to designate the sporting event participant as eligible to advance to a next round of play in an elimination style sports tournament.

12. The wagering system of claim 10, wherein the computer readable code is configured to designate a payout amount for the sporting event participant for each round to which the sporting event participant advances.

13. The wagering system of claim 12, wherein the computer readable code is configured to transmit to the user a user recommendation representing a relative monetary value of the sporting event participant in view of the most recent auction bid.

14. The wagering system of claim 10, wherein the computer readable code is further configured to assign a participating sports team to the user when the user submits a last auction bid for the participating sports team.

15. The wagering system of claim 10, wherein the computer readable code is further configured to receive from at least two users an approval to modify the designated final payout amount.

16. The wagering system of claim 10, wherein the sporting event participant is a sports team.

17. The wagering system of claim 10, wherein the sporting event participant is an individual athlete.
